(19) United States
(12) Patent Application Publication
(10) Pub. No.: US 2009/0287594 A1
(43) Pub. Date: Nov. 19, 2009

(54) Methods of operating a self-service check depositing terminal to provide a tracking receipt

(75) Inventor: Malon S. Updike, Dayton, OH (US)

Correspondence Address: MICHAEL CHAN;NCR CORPORATION, 1700 SOUTH PATTERSON BLVD, DAYTON, OH, 45479-0001, US

(73) Assignee: NCR Corporation

(21) Appl. No.: 12/152,775

(22) Filed: May 16, 2008

(51) Int. Cl. G06Q 40/00

(52) U.S. Cl. 705/35

(57) ABSTRACT

A method of operating a self-service check depositing terminal is provided. The method comprises receiving a check from a depositor, attempting to return the check to the depositor, printing a tracking receipt when the check is unable to be returned to the depositor, and dispensing the printing tracking receipt to the depositor to provide the depositor with information regarding next steps to take to resolve non-return of the check.

### BACKGROUND

The present invention relates to depositing of checks at a self-service check depositing terminal, and is particularly directed to methods of operating a self-service check depositing terminal, such as a check depositing automated teller machine (ATM), to provide a tracking receipt.

In a typical check depositing ATM, an ATM customer is allowed to deposit a check (without having to place the check in any deposit envelope) in a publicly accessible, unattended environment. To deposit a check, the ATM customer inserts a user identification card through a user card slot at the ATM, enters the amount of the check being deposited, and inserts the check to be deposited through a check slot of a check acceptor. A check transport mechanism receives the inserted check and transports the check in a forward direction along a check transport path to a number of locations within the ATM to process the check.

If the check is accepted for deposit, the amount of the check is deposited into the ATM customer's account and the check is transported to a storage bin within the ATM. An endorser printer prints an endorsement onto the check as the check is being transported to and stored in the storage bin. The ATM customer may be charged a service fee for conducting the check deposit transaction. Checks in the storage bin within the ATM are periodically picked up and physically transported via courier to a back office facility of a financial institution for further processing.

If the check is not accepted for deposit, the check transport mechanism transports the check in a reverse direction along the check transport path to return the check to the ATM customer via the check slot. From time to time, the check is unable to be returned to the ATM customer. As an example, the check may have become jammed along the check transport path. If the check is unable to be returned to the ATM customer, the ATM customer may become quite irate since the ATM customer no longer has the check and does not know what to do next. It would be desirable to provide the ATM customer with some indication as what to do next to resolve the non-return of the check.

### SUMMARY

In accordance with one embodiment of the present invention, a method of operating a self-service check depositing terminal is provided. The method comprises receiving a check from a depositor, attempting to return the check to the depositor, printing a tracking receipt when the check is unable to be returned to the depositor, and dispensing the printing tracking receipt to the depositor to provide the depositor with information regarding next steps to take to resolve non-return of the check.

### BRIEF DESCRIPTION OF THE DRAWINGS

In the accompanying drawings:

FIG. 1 is a left-front perspective view of an image-based check depositing automated teller machine (ATM) embodying the present invention;

FIG. 2 is a simplified schematic diagram of a part (a check processing module) of the ATM of FIG. 1;

FIG. 3 is an elevational view of the check processing module of FIG. 2, looking approximately in the direction of arrow X in FIG. 1, and showing some parts removed and some parts only schematically;

FIG. 4 is a flowchart illustrating steps involved in a check deposit transaction; and

FIG. 5 is an illustration of a tracking receipt in accordance with one embodiment of the present invention.

### DETAILED DESCRIPTION

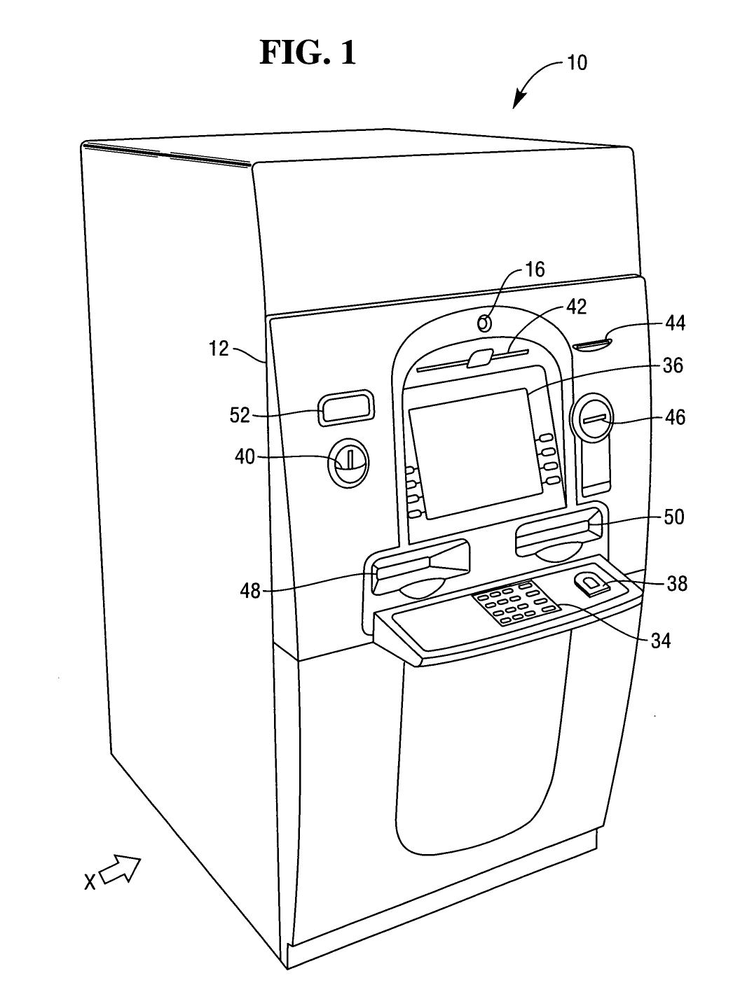

Referring to FIG. 1, a self-service check depositing terminal in the form of an image-based check depositing automated teller machine (ATM) 10 is illustrated. The check depositing ATM 10 comprises a fascia 12 coupled to a chassis (not shown). The fascia 12 defines an aperture 16 through which a camera (not shown) images a customer of the ATM 10. The fascia 12 also defines a number of slots for receiving and dispensing media items, and a tray 40 into which coins can be dispensed. The slots include a statement output slot 42, a receipt slot 44, a card reader slot 46, a cash slot 48, another cash slot 50, and a check input/output slot 52. The slots 42 to 52 and tray 40 are arranged such that the slots and tray align with corresponding ATM modules mounted within the chassis of the ATM 10.

The fascia 12 provides a user interface for allowing an ATM customer to execute a transaction. The fascia 12 includes an encrypting keyboard 34 for allowing an ATM customer to enter transaction details. A display 36 is provided for presenting screens to an ATM customer. A fingerprint reader 38 is provided for reading a fingerprint of an ATM customer to identify the ATM customer. The user interface features described above are all provided on an NCR PERSONAS (trademark) 6676 ATM, available from NCR Financial Solutions Group Limited, Discovery Centre, 3 Fulton Road, Dundee, DD2 4SW, Scotland.

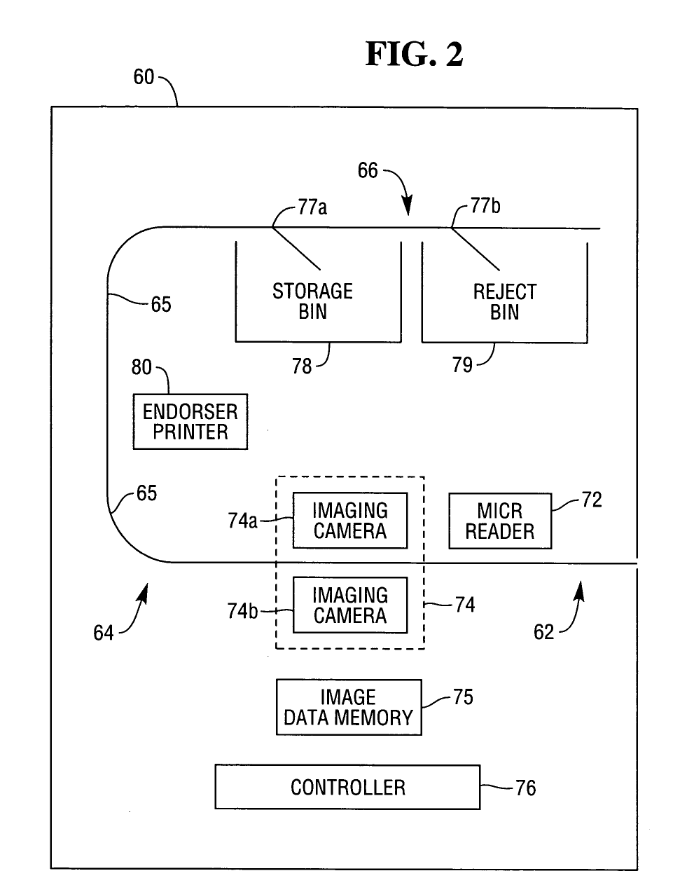

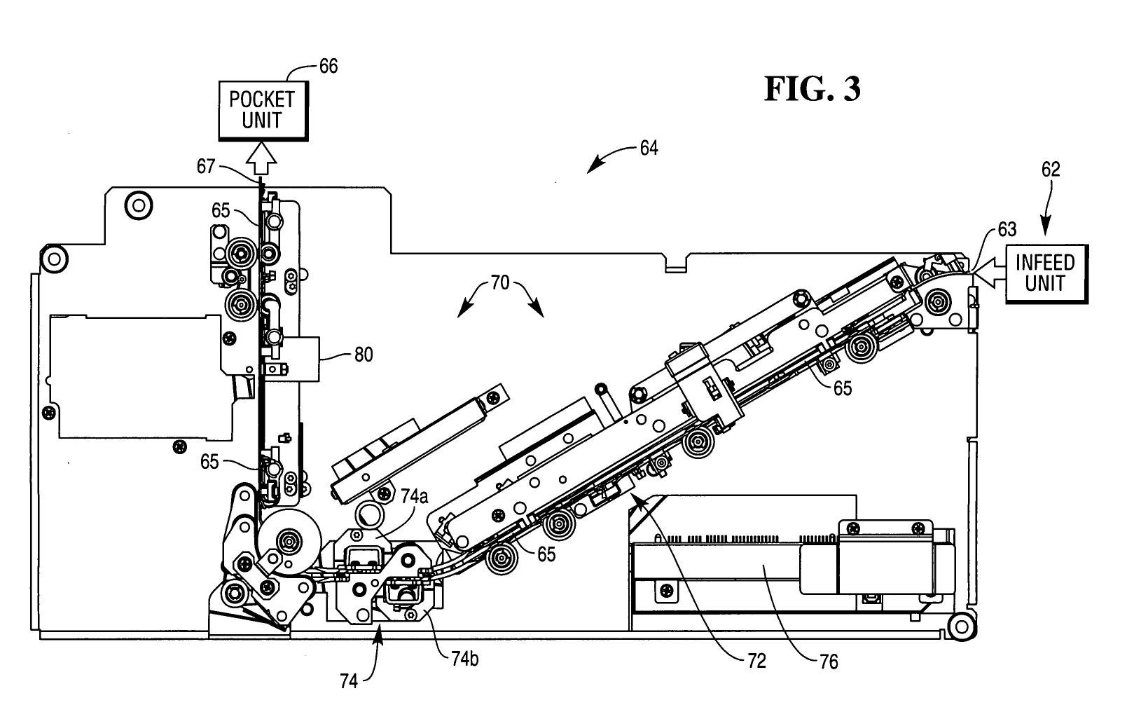

A check processing module (CPM) 60 will now be described with reference to FIG. 2 and FIG. 3. FIG. 2 is a simplified schematic diagram of part of the fascia 12 and main parts of the CPM 60. FIG. 3 is an elevational view of the check processing module of FIG. 2, looking approximately in the direction of arrow X in FIG. 1, and showing some parts removed and some parts only schematically. The CPM 60 is a modified version of a conventional check processing module, such as the check processing module provided with the PERSONAS (trademark) 6676 NCR ATM.

The CPM 60 comprises three main units which includes an infeed unit 62, a transport unit 64, and a pocket unit 66. The infeed unit 62 receives a check which has been deposited into the check input/output slot 42, and transports the check to an inlet 63 of the transport unit 64. The dimensions of the infeed unit 62, such as its run length, may vary depending upon the particular model ATM the CPM 60 is installed. The structure and operation of the infeed unit 62 are conventional and well known and, therefore, will not be described.

The transport unit 64 includes a check input/output transport mechanism 70 which includes an alignment mechanism for aligning a check. The transport mechanism 70 receives a check from the inlet 63, and transports the check along a document track 65 to an outlet 67 of the transport unit 64. The transport unit 64 further includes a magnetic ink character recognition (MICR) head 72 for reading magnetic details on a code line of a check. The transport unit 64 also includes an imager 74 including an upper 74a and lower 74b imaging camera for capturing an image of each side of a check (front and rear). An endorser printer 80 is provided for printing endorsements onto checks. An image data memory 75 is provided for storing images of checks. A controller 76 is provided for controlling the operation of the elements within the CPM 60.

The pocket unit 66 includes a storage bin 78 for storing processed checks. The pocket unit 66 further includes a reject bin 79 for storing rejected checks. Two divert gates 77a, 77b are provided for diverting checks to either the storage bin 78 or the reject bin 79. The structure and operation of the pocket unit 66 are conventional and well known and, therefore, will not be described.

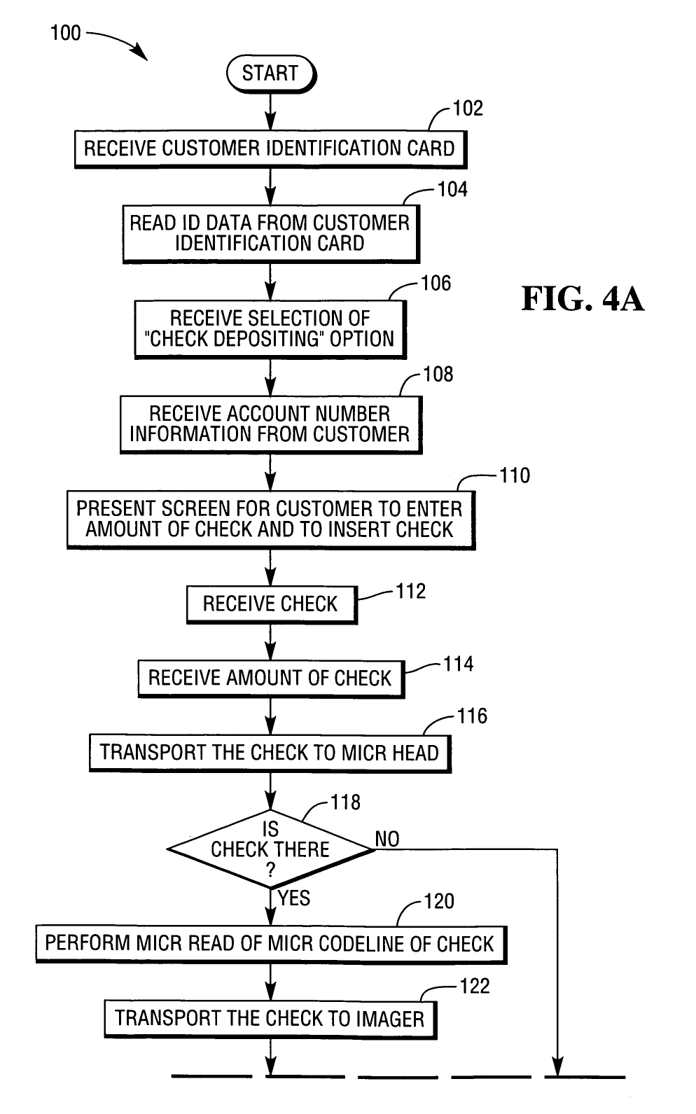

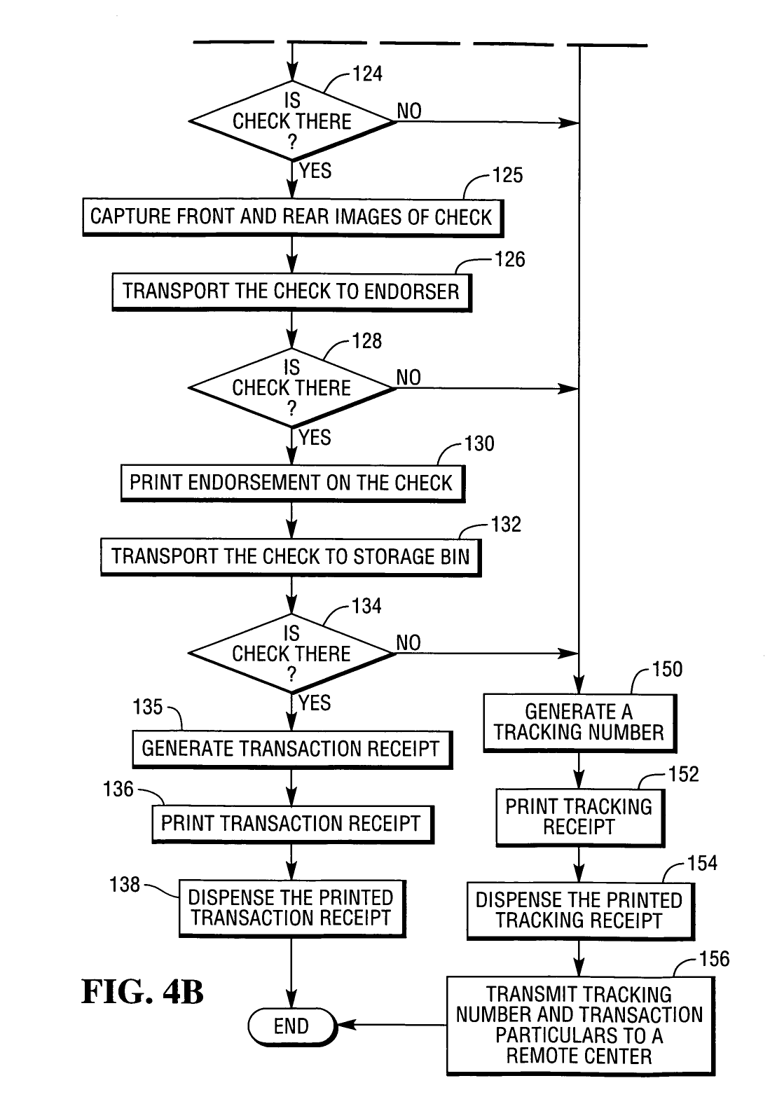

Referring to FIG. 4, a flowchart 100 illustrates steps involved in a check deposit transaction. In the check deposit transaction, the ATM customer inserts a customer identification card into the card reader slot 46 and enters identifying data, like a personal identification number (PIN) to start the transaction (steps 102 and 104). The ATM customer is presented with a screen on the display 36 to select a transaction from a list of transaction options, and selects the “check depositing” option (step 106). The ATM customer also selects an account into which the deposit is to be made (step 108).

The ATM customer is presented with a screen to enter the amount of the check via the keyboard 34, and to insert the check to be deposited through the check input/output slot 52 (step 110). The ATM customer inserts the check (step 112), and enters the amount of the check (step 114). The controller 76 receives the amount of the check. The infeed unit 62 receives the check and transports the check to the inlet 63 of the transport unit 64. The transport mechanism 70 of the transport unit 64 receives the check and transports the check (step 116) to the MICR head 72.

As the check is being transported, a determination is made as to whether the check has reached its intended destination (i.e., the MICR head 72) (step 118). The check may not reach its intended destination as a result of a fault condition, such as a document jam for example. This determination may be made by using sensors at the intended destination to detect presence (or absence) of the check at that location. If the determination in step 118 is negative (i.e., the check has not reached the MICR head 72), then the process proceeds to step 150 which will described in detail later. However, if the determination in step 118 is affirmative, (i.e., the check has reached the MICR head 72), then the MICR codeline on the check is read (step 120).

The transport mechanism 70 then transports the check to the imager 74 (step 122). As the check is being transported, a determination is made as to whether the check has reached its intended destination (i.e., the imager 74) (step 124). If the determination in step 124 is negative (i.e., the check has not reached the imager 74), then the process proceeds to step 150 which will described in detail later. However, if the determination in step 124 is affirmative, (i.e., the check has reached the imager 74), then both sides of the check are imaged (step 125).

The transport mechanism 70 then transports the check to the endorser 80 (step 126). As the check is being transported, a determination is made as to whether the check has reached its intended destination (i.e., the endorser 80) (step 128). If the determination in step 128 is negative (i.e., the check has not reached the endorser 80), then the process proceeds to step 150 which will described in detail later. However, if the determination in step 128 is affirmative, (i.e., the check has reached the endorser 80), then the endorser printer 80 prints endorsement data onto the check (step 130).

The transport mechanism 70 then transports the check to the storage bin 78 of the pocket unit 66 for subsequent collection and further processing (step 132). As the check is being transported, a determination is made as to whether the check has reached its intended destination (i.e., the storage bin 78) (step 134). If the determination in step 134 is affirmative, (i.e., the check has reached the storage bin 78), then a check deposit transaction receipt is generated (step 135) and printed (step 136). The printed check deposit transaction receipt is then dispensed to the ATM customer to provide the ATM customer with a record of the check deposit transaction having occurred (step 138). The check deposit transaction receipt is typical and well known and, therefore, will not be described. The process of the flowchart 100 of FIG. 4 then terminates.

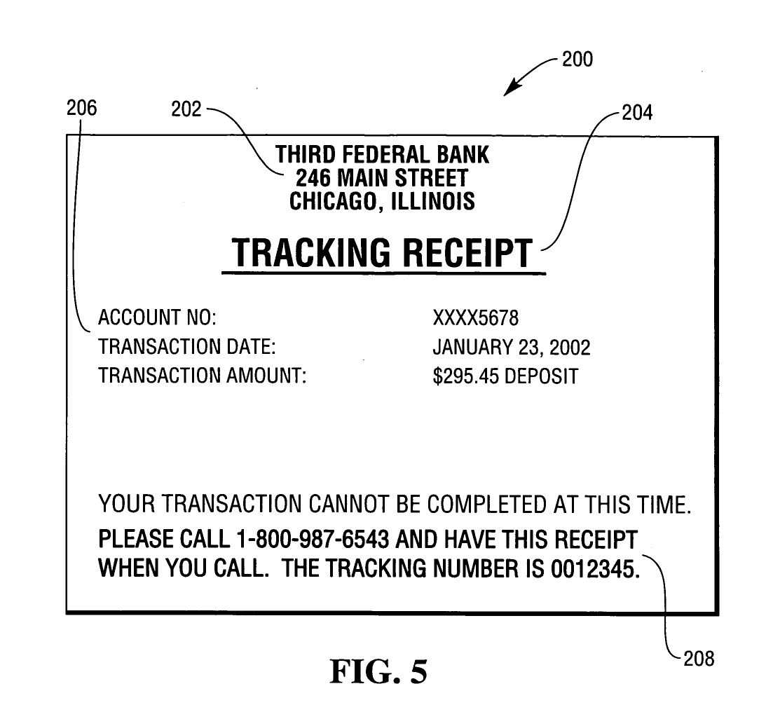

However, if the determination in step 134 is negative (i.e., the check has not reached the storage bin 78), then the process proceeds to step 150 in which a tracking receipt is generated. The generated tracking receipt is then printed (step 152). The tracking receipt generated in step 150 is other than a check deposit transaction receipt (as was described hereinabove with reference to steps 135 and 136). An example of the printed tracking receipt of step 152 is shown in FIG. 5 and designated with reference numeral “200”.

As shown in FIG. 5, the printed tracking receipt 200 contains information 202 about the bank at which the check deposit transaction is being conducted. The tracking receipt 200 also has a line 204 which indicates the document as being a “TRACKING RECEIPT”. The tracking receipt 200 may also contain information 206 relating to the attempted check deposit transaction which has now been terminated because of occurrence of the fault condition (i.e., the document jam condition in this example).

The tracking receipt 200 contains information 208 which will provide the ATM customer with the next steps to follow to resolve the non-return of the check. More specifically, the information 208 has a phone number (i.e., “1-800-987-6543” in this example) of a service provider which the ATM customer can call. Although this phone number is a toll-free number, it is conceivable that the number could be any type of phone number. The information 208 on the tracking receipt 200 also contains a tracking number (i.e., “0012345” in this example) which the ATM customer can provide to the service provider when the ATM customer calls the service provider. The printed tracking receipt 200 is then dispensed to the ATM customer (step 152 in FIG. 4).

After the printed tracking receipt 200 has been dispensed to the ATM customer, the tracking number generated back in step 150 and particulars associated with this attempted check deposit transaction are transmitted to a remote center (step 156). This transmission notifies the remote center of the now terminated check deposit transaction. The transmission also allows the resolution of this situation to be tracked based upon the tracking number. The service provider matches up the tracking number transmitted from the ATM 10 and the tracking number provided by the ATM customer. After the tracking numbers are matched up, the check may be returned to the ATM customer, or the check may be direct-deposited to a financial institution, for examples.

It should be apparent that the tracking receipt 200 provides a tracking mechanism for resolution of the non-return of the check to the ATM customer. The tracking receipt 200 also provides the ATM customer with an improved experience in the event of the occurrence of a fault condition, such as a document jam. The ATM customer knows what next steps to take to resolve the non-return of the check. Moreover, the ATM customer is provided with assurance that the check has not been “lost” even though it has not been deposited.

It is conceivable that a fault condition which results in non-return of a check to an ATM customer may occur at any time during a check deposit transaction. It is also conceivable that a fault condition may occur even before a check reaches a device to process the check. An example of this occurrence is when an ATM customer changes his/her mind about conducting the check deposit transaction after a check has been inserted but before the check has reached a device for processing the check.

Although the above-description describes the PERSONAS (trademark) 6676 NCR ATM embodying the present invention, it is conceivable that other models of ATMs, other types of ATMs, or other types of self-service check depositing terminals may embody the present invention. Self-service depositing terminals are generally public-access devices that are designed to allow a user to conduct a check deposit transaction in an unassisted manner and/or in an unattended environment. Self-service check depositing terminals typically include some form of tamper resistance so that they are inherently resilient.

The particular arrangements disclosed are meant to be illustrative only and not limiting as to the scope of the invention. From the above description, those skilled in the art to which the present invention relates will perceive improvements, changes and modifications. Numerous substitutions and modifications can be undertaken without departing from the true spirit and scope of the invention. Such improvements, changes and modifications within the skill of the art to which the present invention relates are intended to be covered by the appended claims.

1. A computer-implemented method of operating a self-service check depositing terminal, the computer-implemented method comprising:
receiving a check from a depositor;
attempting to return the check to the depositor;
electronically on a processor causing a printer to print a tracking receipt when the check is unable to be returned to the depositor; and
electronically on a processor causing a document transport mechanism to dispense the printed tracking receipt to the depositor to provide the depositor with information regarding next steps to take to resolve non-return of the check.

2. A computer-implemented method according to claim 1, wherein the tracking receipt includes a service provider phone number for the depositor to call to resolve non-return of the check.

3. A computer-implemented method according to claim 2, wherein the tracking receipt includes a tracking number for the depositor to communicate to the service provider when the depositor calls the service provider phone number to resolve non-return of the check.

4. A computer-implemented method according to claim 3, further comprising:
transmitting a notification including the tracking number to a location remote from the self-service check deposit terminal to allow resolution of non-return of the check to be tracked.

5. A computer-implemented method according to claim 1, wherein the tracking receipt includes (i) a tracking number, and (ii) a phone number of a service provider to allow the depositor to call the service provider and communicate the tracking number to the service provider so that the service provider can take next steps to resolve non-return of the check.

6. A computer-implemented method of operating a self-service check depositing terminal to provide a tracking receipt which is other than a deposit transaction receipt, the computer-implemented method comprising:
receiving a check from a depositor;
attempting to return the check to the depositor;
electronically on a processor causing a printer to print a tracking receipt which is other than a deposit transaction receipt and which includes a phone number for the depositor to call when the check is unable to be returned to the depositor due to a fault condition; and
electronically on a processor causing a document transport mechanism to dispense the printed tracking receipt to the depositor to provide the depositor with information regarding next steps to take to resolve non-return of the check.

7. A method according to claim 6, wherein the tracking receipt includes a tracking number for the depositor to communicate to a service provider at the phone number when the depositor calls the phone number to resolve non-return of the check.

8. A computer-implemented method according to claim 7, further comprising:
transmitting a notification including the tracking number to a location remote from the self-service check deposit terminal to allow resolution of non-return of the check to be tracked.

9. A computer-implemented method according to claim 6, wherein the fault condition comprises a document jam condition at the self-service check deposit terminal.

10. A method of operating an automated teller machine (ATM) to provide an ATM customer with a tracking receipt in response to a document jam condition occurring at the ATM, the method comprising:
receiving a request from an ATM customer to conduct a check deposit transaction to deposit a check;
attempting to return the check to the ATM customer;
printing a tracking receipt which is other than a deposit transaction receipt and which includes a service provider phone number for the ATM customer to call when the check is unable to be returned to the depositor due to the document jam condition; and
dispensing the printed tracking receipt to the ATM customer to provide the ATM customer with the service provider phone number to call to obtain further information regarding next steps to take to resolve non-return of the check.

11. A method according to claim 10, wherein the tracking receipt includes a tracking number for the ATM customer to communicate to the service provider when the ATM customer calls the service provider phone number to resolve non-return of the check.

12. (canceled)
